(19) United States
(12) Patent Application Publication
(10) Pub. No.: US 2026/0073234 A1
(43) Pub. Date: Mar. 12, 2026

(54) METHOD AND APPARATUS FOR DETECTING DISRUPTED AGENT IN MULTI-AGENT REINFORCEMENT LEARNING ENVIRONMENT

(71) Applicant: ELECTRONICS AND TELECOMMUNICATIONS RESEARCH INSTITUTE, Daejeon (KR)

(72) Inventors: Seungwoo SEO, Daejeon (KR); Sungwon Yi, Daejeon (KR); Hyun Woo Kim, Daejeon (KR); Hwa Jeon Song, Daejeon (KR); Younghwan Shin, Daejeon (KR); Byunghyun Yoo, Daejeon (KR)

(21) Appl. No.: 19/280,767

(22) Filed: Jul. 25, 2025

(30) Foreign Application Priority Data
Sep. 11, 2024 (KR) 10-2024-0123648

(51) Int. Cl. G06N 3/092

(52) U.S. Cl. CPC G06N 3/092

(57) ABSTRACT

A method and an apparatus for detecting a disrupted agent in multi-agent reinforcement learning environment. An embodiment of the present disclosure provides a method for detecting disrupted agent in multi-agent reinforcement learning environment, including: calculating, by the first agent, an action score for one or more of the actions included in the action space of the second agent, based on one or more of observation information and action space information received from one or more other agents; and determining, based on the action score, whether the second agent is the disrupted agent, wherein the action score is a value calculated based on a value calculated according to a learned policy for each action, and is an index having a higher value for a relatively important action among actions that may be performed by the agent.

### CROSS-REFERENCE TO RELATED APPLICATION

The present application claims priority to Korean Patent Application No. 10-2024-0123648, filed on Sep. 11, 2024 in the Korea Intellectual Property Office, the entire contents of which are incorporated herein by reference.

### TECHNICAL FIELD

The present disclosure relates to a method and an apparatus for detecting a disrupted agent in multi-agent reinforcement learning environment.

### BACKGROUND

The statements in this section merely provide background information related to the present disclosure and do not necessarily constitute prior art.

Multi-Agent Reinforcement Learning (MARL) is a technique in which a plurality of agents interact and learn how to maximize a reward by cooperating or competing in a given environment. Each agent individually observes the environment and performs an action accordingly, thereby aiming to achieve a common objective of improving the performance of the overall system. In this environment, agents recognize the environment in which they are located, and cooperate with other agents by exchanging observation information or action space information.

In reinforcement learning, each agent makes decisions based on the reward received and a learned policy, and in a multi-agent environment, not only the performance of individual agents but also the performance of the overall system becomes an important factor. Therefore, in cooperative multi-agent reinforcement learning (Cooperative MARL), smooth information exchange between agents is essential. However, there is a possibility that some agents may behave abnormally due to external attacks, which may degrade system performance.

In order to prevent this, there is a need for a method and an apparatus capable of detecting abnormal actions of other agents, that is, a method and an apparatus capable of detecting whether agent is disrupted agent.

### SUMMARY

An object of the present disclosure is to provide a method and an apparatus for detecting a disrupted agent in multi-agent reinforcement learning environment. Specifically, a main object of the present invention is to provide a method and an apparatus for efficiently detecting a disrupted agent by calculating an action score for an action that may be performed by an agent and determining, based on the action score, whether the action of the agent is an abnormal action, that is, whether that agent is the disrupted agent.

The technical objects of the present disclosure are not limited to those described above, and other technical objects not mentioned above may be understood clearly by those skilled in the art from the descriptions given below.

An embodiment of the present disclosure provides a method for detecting disrupted agent in multi-agent reinforcement learning environment, including: calculating, by the first agent, an action score for one or more of the actions included in the action space of the second agent, based on one or more of observation information and action space information received from one or more other agents; and determining, based on the action score, whether the second agent is the disrupted agent, wherein the action score is a value calculated based on a value calculated according to a learned policy for each action, and is an index having a higher value for a relatively important action among actions that may be performed by the agent.

Another embodiment of the present disclosure provides an apparatus for detecting a disrupted agent in multi-agent reinforcement learning environment, the apparatus including: at least one memory storing instructions; and at least one processor, wherein at least one processor is configured to execute the instructions to perform: calculating, by the first agent, an action score for one or more of the actions included in the action space of the second agent, based on one or more of observation information and action space information received from one or more other agents; and determining, based on the action score, whether the second agent is the disrupted agent, wherein the action score is a value calculated based on a value calculated according to a learned policy for each action, and is score having a higher value for a relatively important action among actions that the agent may perform.

According to an embodiment of the present disclosure, it is possible to improve the performance of the overall system in the multi-agent environment by detecting the disrupted agent based on the action score.

According to an embodiment of the present disclosure, it is possible to reduce a bandwidth required for inter-agent communication in the multi-agent environment by excluding commonly shared information from the information to be transmitted between agents.

According to an embodiment of the present disclosure, it is possible to reduce the bandwidth required for inter-agent communication in the multi-agent environment by selecting information to be transmitted between agents based on a new information amount.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a diagram schematically showing a configuration of an agent according to an embodiment of the present disclosure.

FIG. 2 is a diagram illustrating an arrangement of a first agent, a second agent, and other agent according to an embodiment of the present disclosure.

FIG. 3 is a flowchart schematically showing a method for detecting a disrupted agent, according to an embodiment of the present disclosure.

FIG. 4 is a diagram illustrating arrangement of a first object and a second object for describing adjustment of an action score, according to an embodiment of the present disclosure.

FIG. 5 is a diagram illustrating an overlap between an observation range of the first agent and an observation range of the second agent for describing adjustment of the action score, according to an embodiment of the present disclosure.

FIG. 6 is a flowchart schematically showing a method in which other agent transmits information to the first agent, according to an embodiment of the present disclosure.

FIG. 7 is a diagram for describing a method of selecting information based on a distance between the first agent and the object when other agent transmits information to the first agent, according to an embodiment of the present disclosure.

FIG. 8 is a block diagram illustrating an exemplary computing device that may be used for implementing a method or an apparatus according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

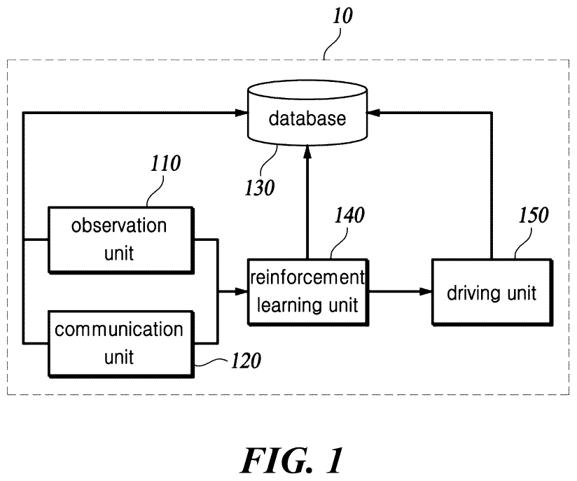

FIG. 1 is a diagram schematically showing a configuration of an agent according to an embodiment of the present disclosure.

Referring to FIG. 1, the agent 10 may include an observation unit 110, a communication unit 120, a database 130, a reinforcement learning unit 140, and a driving unit 150. The agent 10 may be one agent included in a multi-agent reinforcement learning environment.

The observation unit 110 may observe objects around the agent. The object may be the agent or a landmark or other object. If the object is the agent, the object may be an agent that includes the same configuration as agent 10. If the object is the landmark, the agent 10 may recognize the environment in which it is located by observing the object. If the object is other object, the object may be an object that is a target of an action performed by the agent 10, for example, an object that is the target of an attack or an object that is the target of collection. The object that is the target of collection may be a resource.

The communication unit 120 may exchange information with other agents. That is, information held by the agent may be transmitted to other agents, or information held by other agent may be acquired. The information may include action space information or observation information. The action space information may include information on all actions that the agent itself may currently perform, i.e., the action space. The observation information may include information observed by the agent with respect to objects included in an observation range of the agent. The action space information and the observation information may be changed based on a task of the agent. The task of the agent may vary depending on the environment to which the agent belongs. The task of the agent may be a cooperative task. The information acquired by the observation unit 110 and the communication unit 120 may be stored in the database 130.

The reinforcement learning unit 140 may learn an appropriate policy in a training process and select an optimal action in a given environment based on the learned policy. The information related to the policy learned and the action selected by the reinforcement learning unit 140 may be stored in the database 130.

The driving unit 150 may actually perform the action determined by the reinforcement learning unit. A process of actually performing the action determined by the reinforcement learning unit may include a process of executing the operation of the agent in a physical environment or a simulation environment. The physical environment may refer to a physical space in the real world, or may refer to a virtual environment in which interactions with the operation of the real environment are modeled through software. Information related to actions performed by the driving unit 150 may be stored in the database 130.

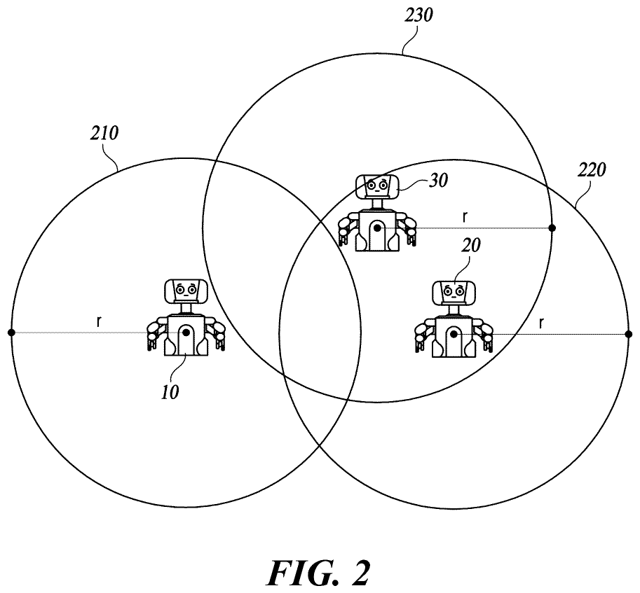

FIG. 2 is a diagram illustrating an arrangement of a first agent, a second agent, and other agent according to an embodiment of the present disclosure.

Referring to FIG. 2, a first agent 10, a second agent 20, and other agent 30 are shown. Each of the first agent 10, the second agent 20, and the other agent 30 may be agents of the same type belonging to the multi-agent reinforcement learning environment, which are only named differently for convenience. In other words, the first agent 10, the second agent 20, and the other agent 30 may all include the configuration as illustrated in FIG. 1.

Each of the first agent 10, the second agent 20, and the other agent 30 may have a predetermined observation range. Referring to FIG. 1, the agent may observe objects included in the observation range by using the observation unit 110. That is, the agent may acquire information observed with respect to the objects included in the observation range, i.e., observation information, by using the observation unit 110. Referring to FIG. 2, the first agent 10, the second agent 20, and the other agent 30 may be located at the center of a circle having a radius of r, and each agent may observe objects located inside the circle to which it belongs. In other words, the observation range of the first agent 10 may be the first circle 210, the observation range of the second agent may be the second circle 220, and the observation range of the other agent 30 may be the third circle 230. For example, since the third agent 30 is located within the second circle 220 which is the observation range of the second agent 20, the second agent 20 may observe the third agent 30. Likewise, since the second agent 20 is located within the third circle 230 which is the observation range of the third agent 30, the third agent 30 may observe the second agent 20.

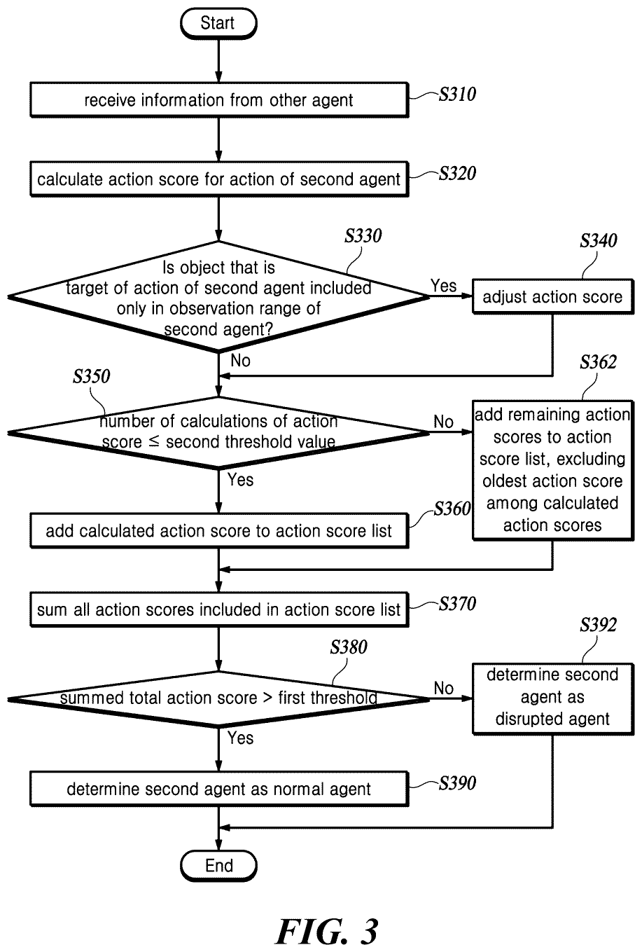

FIG. 3 is a flowchart schematically showing a method for detecting a disrupted agent, according to an embodiment of the present disclosure.

In the present disclosure, it is assumed that steps S310 to S340 are described from the perspective of one agent included in the multi-agent environment. One agent may be the first agent 10.

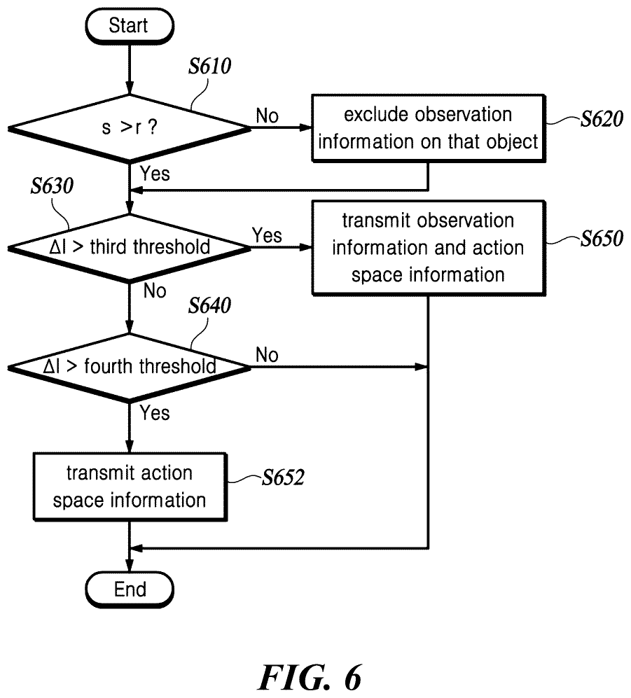

Referring to FIG. 3, the first agent 10 receives information from the other agent 30 (S310). The information received by the first agent may include one or more of action space information and observation information of the other agent 30. A method by which the other agent 30 transmits information to the first agent 10 and criteria for determining information to be transmitted will be described in detail below with reference to FIG. 6.

The first agent 10 calculates the action score for the action of the second agent 20 (S320). The action score may be calculated based on information held by the first agent 10 at the time of calculating the action score. The information held by the first agent 10 at the time of calculating the action score may include information received by the first agent 10 from the other agent 30. That is, the action score may be calculated based on information received by the first agent 10 from the other agent 30. Equation 1 is an equation for calculating the action score.

$${{a}^{x}}_{ij} = \frac{{e}^{{q}_{x}} / h}{{\sum }_{k = 1}^{K} {e}^{{q}_{k}}} \qquad [ Equation 1 ]$$

axij is an action score calculated for a specific action x of agent j from the perspective of agent i. K is the total number of actions belonging to the action space of agent j. qx is the value of a specific action x belonging to the action space of agent j. The value may be calculated from the perspective of agent i. The value may be a value that each agent calculates individually based on a policy and information held by itself. That is, the value may vary from agent to agent. h is any value between 0 and 1. The action space, as described above, is a set including all actions currently performable by the agent itself.

The first agent 10 calculates the action score ax12 for each of all actions belonging to the action space of the second agent 20 based on Equation 1. The action score for the action that the second agent 20 may not perform is 0. When action scores are respectively calculated for all actions that the second agent 20 may perform, that is, for all actions included in the action space of the second agent 20, and the calculated action scores are summed, the result is 1.

The first agent 10 determines whether an object that is a target of an action performed by the second agent 20 is included only in the observation range of the second agent 20 (S330). When the object that is the target of the action performed by the second agent 20 is included only in the observation range of the second agent 20, the first agent 10 adjusts the action score (S340). The case in which the object that is the target of the action of the second agent 20 is included only in the observation range of the second agent 20 refers to a case in which the object that is the target of the action of the second agent 20 is not included in the observation range of the first agent 10, but is included in the observation range of the second agent 20.

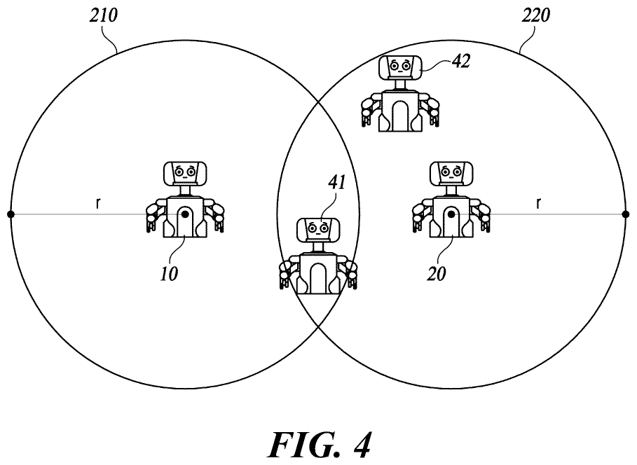

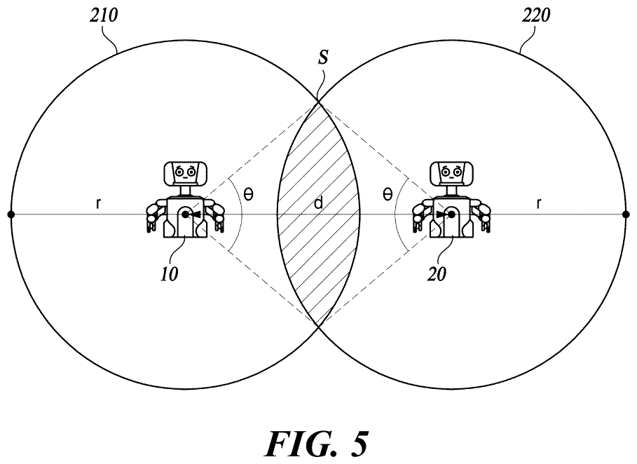

FIG. 4 is a diagram illustrating arrangement of a first object and a second object for describing adjustment of an action score, according to an embodiment of the present disclosure. FIG. 5 is a diagram illustrating an overlap between an observation range of the first agent and an observation range of the second agent for describing adjustment of the action score, according to an embodiment of the present disclosure.

Referring to FIG. 4, when compared with FIG. 2, a first object 41 and a second object 42 are further shown.

In the case of the first object 41, it is included in the observation range of the first agent 10, i.e., the first circle 210, and at the same time, the observation range of the second agent 20, i.e., the second circle 220. Therefore, for an action that the second agent 20 may perform on the first object 41, among the actions that may be performed by the second agent 20, the action score calculated by the first agent 10 for the second agent 20 is not adjusted. In other words, when the action that the second agent 20 may perform on the first object 41, among the actions that may be performed by the second agent 20, is x1, ax112 is not adjusted. In the case of objects present in overlapping observation ranges, both the first agent 10 and the second agent 20 may observe, so that the action score of the second agent 20 with respect to these objects is not adjusted in the sense that it is reliable from the viewpoint of the first agent 10. The fact that it is reliable from the viewpoint of the first agent 10 may mean that the action score ax112 calculated by the first agent 10 may be considered reliable. The reason why the action score ax112 calculated by the first agent 10 may be considered reliable is that, from the perspective of the first agent 10, ax112 is calculated based on value qx1 calculated for action x1 that the second agent 20 may perform on the first object 41 (the first object 41 may be observed by the first agent 11).

In the case of the second object 42, it is included in the observation range of the second agent 20, i.e., the second circle 220, but not in the observation range of the first agent 10, i.e., the first circle 210. Therefore, for an action that the second agent 20 may perform on the second object 42, among the actions that may be performed by the second agent 20, the action score calculated by the first agent 10 for the second agent 20 is adjusted. In other words, when the action that the second agent 20 may perform on the second object 42, among the actions that may be performed by the second agent 20, is x2, ax212 is adjusted. In the case of objects present in non-overlapping observation ranges, in particular in the case of objects which are outside the observation range of the first agent 10, the second agent 20 may observe them but the first agent 10 may not, so that the action score of the second agent 20 with respect to these objects is adjusted in the sense that the action is not reliable from the viewpoint of the first agent 10. The fact that it is not reliable from the viewpoint of the first agent 10 may mean that the action score ax212 calculated by the first agent 10 may be considered reliable. The reason why the action score ax212 calculated by the first agent 10 may be considered reliable is that, from the perspective of the first agent 10, ax212 is calculated based on value qx2 calculated for action x2 that the second agent 20 may perform on the second object 42 (the second object 42 may not be observed by the first agent 11).

The action score may be adjusted based on a ratio at which the observation range of the first agent 10 and the observation range of second agent 20 overlap. Specifically, the action score may be adjusted by calculating an area of a region where the observation range of the first agent 10 and the observation range of the second agent 20 overlap, calculating a ratio of the area of the overlapping region to an area of one observation range of the agent based on the calculated area, and multiplying the calculated ratio by the action score. Equation 2 is an equation for calculating an area of a region where the observation range of the first agent 10 and the observation range of the second agent 20 overlap. Equation 3 is an equation for calculating θ based on the observation range of each agent and the distance between each agent.

$$S = {r}^{2} ( θ - sin θ ) \qquad [ Equation 2 ]$$

$$θ = 2 {cos}^{- 1} \frac{{d}^{2}}{2 dr} \qquad [ Equation 3 ]$$

Referring to FIG. 5 and Equation 2, S is an area of a region where the observation range of the first agent 10 and the observation range of the second agent 20 overlap. r is the radius of the first circle 210 and the second circle 220. In the present disclosure, it may be assumed that the observation range of each agent is the same. For example, the radius of the first circle 210 and the radius of the second circle 220 may be equal to r. θ is an angle formed by respective line segments connecting two points where the first circle 210 and the second circle 220 intersect with each other from the center of the first circle 210, and an arc connecting the two intersecting points. Similarly, θ is an angle formed by respective line segments connecting two points where the first circle 210 and the second circle 220 intersect with each other from the center of the second circle 220 and an arc connecting the two intersecting points.

Referring to FIG. 5 and Equation 3, d is the distance between the first agent 10 and the second agent 20. In the present disclosure, it may be assumed that each of the first agent 10 and the second agent 20 is located at the center of each of the first circle 210 and the second circle 220.

Equation 4 is an equation for calculating a ratio of an area of an overlapping region to an area of an observation range of one agent.

$$T = \frac{S}{π {r}^{2}} \qquad [ Equation 4 ]$$

Referring to Equation 4, T is the ratio of the area of the overlapping region to the area of the observation range of one agent. S is the area of the region where the observation range of the first agent 10 and the observation range of the second agent 20 overlap. r is the radius of the first circle 210 and the second circle 220. The first agent 10 adjusts the action score ax212 by multiplying the action score ax212 calculated with respect to the second object 42 by T. T may be referred to as “reliability.”

The first agent 10 does not adjust the action score in a case where the object that is a target of the action of the second agent 20 is included in both the observation range of the first agent 10 and the observation range of the second agent 20.

In the present disclosure, it is assumed that steps S350 to S392 are described in consideration of all agents included in the multi-agent environment. That is, the apparatus for detecting a disrupted agent according to an embodiment of the present disclosure may repeatedly perform steps S310 to S340 with respect to a plurality of agents, although the steps are described with respect to one agent. As the step S320 is repeated, the action score may be calculated multiple times. As a result, a plurality of action scores may be generated. As the steps S330 to S340 is repeated, some of the plurality of action scores may be adjusted. In other words, the apparatus for detecting a disrupted agent according to an embodiment of the present disclosure may calculate and adjust the action score for the second agent 20 from the perspective of not only the first agent 10 but also all agents included in the multi-agent environment. The apparatus for detecting a disrupted agent may be implemented using a computing device 80. The computing device 80 may include a processor 820.

Here, the disrupted agent is an expression that means an agent that behaves abnormally due to an external attack. The disrupted agent may be referred to as a disrupted agent, in the sense that it has been disrupted by the external attack.

Referring to FIG. 3, the processor 820 determines whether the number of calculations of the action score is less than or equal to the second threshold (S350). The number of calculations of the action score may be the number of times the action score has been calculated. That is, the number of calculations of the action score may be the same as the number of repetitions of the step S320.

The processor 820 adds the action score to an action score list when the number of calculations of the action score is less than or equal to a second threshold value (S360). The processor 820 adds the remaining action scores, excluding the oldest action score among the calculated action scores, to the action score list when the number of calculations of the action score is greater than the second threshold (S362). The action score list may be an array including one or more action scores. The action score list may have a predetermined size of the array. Therefore, when the number of calculations of the action score is greater than the second threshold, the processor 820 may determine that the data size of the calculated action score is larger than the size of the action score list, and add the remaining action scores excluding the oldest action score to the action score list. In other cases, that is, when the number of calculations of the action score is less than or equal to the second threshold value, the processor 820 may determine that the data size of the calculated action score is not greater than the size of the action score list, and add the all of calculated action score to the action score list. The action score may be added to the action score list in the order in which they are calculated.

The processor 820 sums all the action scores included in the action score list (S370). That is, the processor 820 may obtain the sum of the action scores included in the action score list.

The processor 820 determines whether the sum of the action scores is greater than a first threshold value (S380). The processor 820 determines whether the second agent is the disrupted agent based on a result of comparing the sum of the action scores with the first threshold. Specifically, when the sum of the action scores is greater than the first threshold, the processor 820 determines that the second agent is a normal agent (S390). Otherwise, when the sum of the action scores is less than the first threshold, the processor 820 determines that the second agent is the disrupted agent (S392).

FIG. 6 is a flowchart schematically showing a method in which other agent transmits information to the first agent, according to an embodiment of the present disclosure.

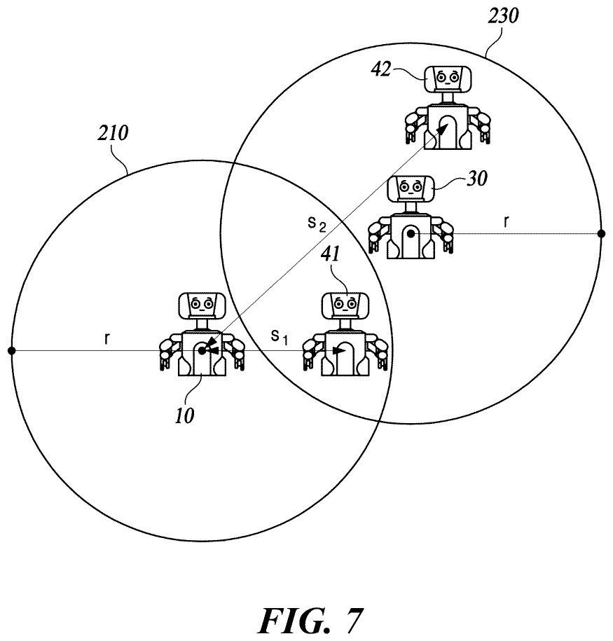

FIG. 7 is a diagram for describing a method of selecting information based on the distance between the first agent and the object when other agent transmits information to the first agent, according to an embodiment of the present disclosure.

The other agent 30 having the same configuration as the first agent 10 may perform steps S610 to S652 using the communication unit 120.

Referring to FIG. 6, the other agent 30 determines whether the distance between the first agent 10 and the object is greater than the observation radius (S610). Referring to FIG. 7, the distance from the first agent 10 to the first object 41 is denoted as s1, and the distance from the second agent 10 to the second object 42 is denoted as s2. The other agent 30 may calculate s1 and s2 based on the relative coordinate of the first agent 10 and the relative coordinates of the first object 41 and the second object 42, with respect to the other agent 30. The observation radius may be r, which is the radius of the first circle 210 and the second circle 220.

The other agent 30 excludes observation information on that object from observation information to be transmitted to the first agent 10, when the distance between the first agent 10 and the object is not greater than the observation radius (S620). This is because, in a case where the distance between the first agent 10 and the object is not greater than the observation radius, both the other agent 30 and the first agent 10 are able to observe the object, and thus thus it is unnecessary for the other agent 30 to transmit the observation information on the object to the first agent 10. That is, the first agent 10 already holds the observation information about the first object 41, so that the other agent 30 does not need to separately transmit the observation information on the first object 41 to the first agent. In this way, it is possible to reduce a bandwidth required for inter-agent communication in the multi-agent environment by excluding commonly shared information from the information to be transmitted between agents.

The other agent 30 may compare the new observation information with the third threshold and a fourth threshold, and, according to the result of the comparison, may transmit one or more of observation information and action space information, or may transmit none of them. The new observation information may be observation information newly acquired by the other agent 30 in the current cycle. In other words, the new observation information may be a difference between the observation information newly acquired by the other agent 30 in the current cycle and the observation information newly acquired by the other agent 30 in the immediately preceding cycle. Equation 5 is an equation for calculating new observation information. The observation information may be acquired at regular intervals by using the observation unit 110 included in the agent.

$$Δ I = \frac{\sqrt{{( {o}_{1}^{t} - {o}_{1}^{t - 1} )}^{2} + {( {o}_{2}^{t} - {o}_{2}^{t - 1} )}^{2} + {( {o}_{k}^{t} - {o}_{k}^{t - 1} )}^{2}}}{k} \qquad [ Equation 5 ]$$

Referring to Equation 5, ΔI is the new observation information, and o^{t}ₖ is the observation information on the k-th object at time t. In the present disclosure, ΔI refers to a new information amount that quantifies the difference between the current and previous observation information, numerically expressing the degree of change to enable threshold-based comparison. For example, o^{t}₁ is the observation information on the first object at time t, and o^{t-1}₁ is the observation information on the first object at a time t−1. The time t may be the current period, and the time t−1 may be the immediately preceding period.

The other agent 30 determines whether the new observation information is greater than the third threshold (S630). The other agent 30, when the new observation information is greater than the third threshold, transmits the observation information and the action space information to the first agent 10 (S650). The other agent 30 may encode and transmit the observation information and the action space information.

The other agent 30, when the new observation information is not greater than the third threshold, determines whether the new observation information is greater than the fourth threshold value (S640). The other agent 30, when the new observation information is not greater than the third threshold but is greater than the fourth threshold, transmits the action space information to the first agent 10 (S652). The other agent 30 may encode and transmit the action space information. As such, it is possible to reduce the bandwidth required for inter-agent communication in the multi-agent environment by selecting information to be transmitted between agents based on a new information amount.

The other agent 30 does not transmit information to the first agent 10 when the new observation information is not greater than the third threshold and is not greater than a fourth threshold.

In the present disclosure, the process in which the other agent 30 transmits information to the first agent 10 has been described with reference to FIGS. 6 to 7, and the process in which the first agent 10 calculates the action score for the second agent 20 and determines whether the second agent 20 is the disrupted agent based on the action score has been described with reference to FIGS. 3 to 5, but this is for convenience of description. Depending on the embodiment, there may be a case where the other agent 30 is the same as the second agent 20.

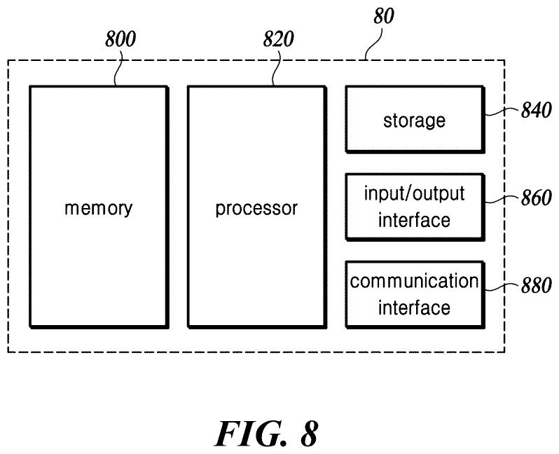

FIG. 8 is a block diagram illustrating an exemplary computing device that may be used for implementing a method or an apparatus according to the present disclosure.

The computing device 80 may include all or part of a memory 800, a processor 820, a storage 840, an input/output interface 860, and a communication interface 880. The computing device 80 may be a stationary computing device, such as a desktop computer or a server, or a mobile computing device, such as a laptop computer or a smart phone. The computing device 80 may include a specialized hardware accelerator capable of processing operations of an artificial intelligence model in an efficient manner. For example, the computing device 80 may include a graphic processing unit (GPU), a tensor processing unit (TPU), or a neural processing unit (NPU). The apparatus for detecting a disrupted agent according to an embodiment of the present disclosure may be implemented by using the computing device 80.

The memory 800 may store a program that enables the processor 820 to perform methods or operations according to various embodiments of the present disclosure. For example, a program may include a plurality of instructions executable by the processor 820, and the methods or operations described above may be performed by executing the plurality of instructions by the processor 820. For example, by executing the plurality of instructions by the processor 820, the steps S350 to S392 of FIG. 3 may be performed. The memory 800 may consist of a single memory or a plurality of memories. In this case, information required to perform the methods or operation according to various embodiments of the present disclosure may be stored in a single memory or distributed across a plurality of memories. When the memory 800 is composed of a plurality of memories, the plurality of memories may be physically separated. The memory 800 may include at least one of volatile memory and non-volatile memory. Volatile memory includes Static Random Access Memory (SRAM) or Dynamic Random Access Memory (DRAM), while non-volatile memory includes flash memory.

The processor 820 may include at least one core capable of executing at least one instruction. The processor 820 may execute instructions stored in the memory 800. The processor 820 may consist of a single processor or a plurality of processors.

The storage 840 maintains stored data even if power supplied to the computing device 80 is cut off. For example, the storage 840 may include non-volatile memory or may include a storage medium such as a magnetic tape, an optical disk, or a magnetic disk. A program stored in the storage 840 may be loaded into the memory 800 before being executed by the processor 820. The storage 840 may store files written in a program language, and a program created from the files by a compiler may be loaded into the memory 800. The storage 840 may store data to be processed by the processor 820 and/or data processed by the processor 820.

The input/output interface 860 may provide an interface with an input device such as a keyboard or a mouse and/or an output device such as a display device or a printer. The user may trigger execution of a program by the processor 820 through the input device and/or check the processing results of the processor 820 through the output device.

The communication interface 880 may provide access to an external network. The computing device 80 may communicate with other devices through the communication interface 880.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A method for detecting disrupted agent in multi-agent reinforcement learning environment, comprising:
calculating, by the first agent, an action score for one or more of the actions comprised in the action space of the second agent, based on one or more of observation information and action space information received from one or more other agents; and
determining, based on the action score, whether the second agent is the disrupted agent,
wherein the action score is a value calculated based on a value calculated according to a learned policy for each action, and is an index having a higher value for a relatively important action among actions that may be performed by the agent.

2. The method of claim 1, wherein:
determining, based on the action score, whether the second agent is the disrupted agent comprises:
summing all the action scores comprised in an action score list; and
comparing the summed action score with a first threshold to determine whether the second agent is the disrupted agent,
wherein the action score is added to the action score list in view of a size of the action score list.

3. The method of claim 1, further comprising:
adjusting the action score; and
determining, based on the adjusted action score, whether the second agent is the disrupted agent,
wherein the adjusting the action score comprises:
determining, for one or more of the actions comprised in the action space of the second agent, whether an object that is a target of an action performed by the second agent is an object located within an observation range of the first agent and an observation range of a second agent; and
multiplying the action score by a score calculated based on a degree to which the observation range of the first agent and the observation range of the second agent overlap, in a case where, as a result of the determination, when the object is comprised only in the observation range of the second agent.

4. The method of claim 1, wherein:
the observation information and the action space information are information transmitted by the other agent to the first agent based on a preset condition, and
the preset condition causes the other agent to transmit one or more of the observation information and the action space information, by comparing new observation information, calculated based on observation information acquired with respect to the object located within the observation range of the other agent, with one or more threshold values.

5. The method of claim 4, wherein:
the observation information is information excluding observation information acquired with respect to object located within both the observation range of the other agent and the observation range of the first agent, among observation information acquired by the other agent with respect to the object located within the observation range of the other agent.

6. The method of claim 4, wherein:
the transmitting one or more of the observation information and the action space information to the first agent based on result of comparing the new observation information with threshold value comprises:
transmitting the observation information and the action space information when the new observation information is greater than a third threshold value; and
transmitting the action space information when the new observation information is less than or equal to the third threshold value and greater than a fourth threshold value.

7. The method of claim 4, wherein:
the new observation information is calculated based on a difference between observation information acquired by the other agent in a current cycle and observation information acquired by the other agent in an immediately preceding cycle.

8. An apparatus for detecting a disrupted agent in multi-agent reinforcement learning environment, the apparatus comprising:
at least one memory storing commands; and
at least one processor,
wherein, by executing the commands, the at least one processor is to:
calculating, by the first agent, an action score for one or more of the actions comprised in the action space of the second agent, based on one or more of observation information and action space information received from one or more other agents; and
determining, based on the action score, whether the second agent is the disrupted agent,
wherein the action score is a value calculated based on a value calculated according to a learned policy for each action, and is score having a higher value for a relatively important action among actions that may be performed by the agent.

9. A computer program stored in a computer-readable recording medium for executing each process comprised in the method according to claim 1.
